(19) United States
(12) Patent Application Publication
(10) Pub. No.: US 2018/0165179 A1
(43) Pub. Date: Jun. 14, 2018

(54) DETERMINING INCOMPATIBILITIES OF AUTOMATED TEST CASES WITH MODIFIED USER INTERFACES

(71) Applicant: NIIT Technologies Ltd, New Delhi (IN)

(72) Inventors: Kishore Negi, Bangalore (IN); Kumud Iyer, Bangalore (IN); Manoj Agarwal, Greater Noida (IN)

(21) Appl. No.: 15/378,075

(22) Filed: Dec. 14, 2016

(51) Int. Cl. G06F 11/36; G06F 9/44

(52) U.S. Cl. CPC G06F 11/3672; G06F 8/38

(57) ABSTRACT

An aspect of the present disclosure determines incompatibilities of automated test cases with modified user interfaces. In one embodiment, a mapping data between test cases in a test suite and user interface (UI) elements in the user interfaces of an application (tested using said test suite) is maintained, with mapping data indicating for each test case, the corresponding UI elements that the test case is designed to test. In response to receiving a modified (version of the) application that is to be tested with the same test suite, a set of UI elements (of the application) that are defective in the user interfaces of the modified application is found. Test cases that would fail are then identified based on the mapping data and the set of defective UI elements. The identified test cases are then reported as having incompatibility with the user interfaces of the modified application.

### BACKGROUND OF THE DISCLOSURE

### Technical Field

The present disclosure relates to testing of enterprise systems and more specifically to determining incompatibilities of automated test cases with modified user interfaces.

### Related Art

Test cases are often employed to check whether an application operates consistent with desired functionalities. Automated test cases provide a convenient approach to testing an application. Each (automated) test case is in the form of a test script containing instructions that are performed by test automation software against the application.

The test automation software typically executes a collection of test cases (referred to as test suite) in a contiguous manner. In other words, execution of the test cases in the test suite is continued without requiring human intervention irrespective of the success or failure (actual outcome does not match expected outcome) of prior test cases.

Many of the automated test cases are directed to user interfaces of the application. A user interface entails aspects such as receiving of inputs from users for the application and displaying the outputs generated by the application, as is well known in the relevant arts. In one embodiment, a user records interactions (e.g., providing the inputs) with the user interface with the test automation software thereafter generating a test script corresponding to such recorded interactions.

User interfaces are often modified when adapting the application to new requirements (for example, as a different newer version). However, modifications to a user interface may give rise to incompatibilities of the prior automated test cases with the modified user interface. Aspects of the present disclosure are directed to determining such incompatibilities.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present invention can be implemented.

FIG. 2 is a flow chart illustrating the manner in which incompatibilities of automated test cases with modified user interfaces is determined according to an aspect of the present disclosure.

FIGS. 3A and 3B depicts sample user interfaces provided by an application in one embodiment.

FIG. 4A depicts portions of an object data specifying the details of UI elements in the user interfaces of an application under test in one embodiment.

FIG. 4B depicts portions of a mapping data specifying which of the test cases in a test suite are designed to test which of the UI elements of an application under test in one embodiment.

FIGS. 5A and 5B depicts sample user interfaces provided by a modified application in one embodiment.

FIG. 6 illustrates the manner in which test cases in a test suite that have incompatibility with the modified user interfaces of a modified application is determined in one embodiment.

FIG. 7 is a block diagram illustrating the details of digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure determines incompatibilities of automated test cases with modified user interfaces. In one embodiment, a mapping data between test cases in a test suite and user interface (UI) elements in the user interfaces of an application is maintained, where the test suite is designed to test the functionalities of the application. The mapping data indicates for each test case, the corresponding UI elements that the test case is designed to test.

In response to receiving a modified (version of the) application that is to be tested with the same test suite, a set of UI elements (of the application) that are defective in the user interfaces of the modified application is found. A set of test cases that would fail is then identified based on the mapping data and the set of defective UI elements. In one embodiment, a test case is included in the identified set only if the test case is designed to test at least one UI element contained in the set of defective UI elements.

The identified set of test cases is then reported (e.g. displayed) as having incompatibility with the user interfaces of the modified application. As such, a tester/user may modify/correct the reported set of test cases prior to execution of the test suite. According to an aspect of the present disclosure, the turn-around time for identifying and fixing defects related to the user interfaces of an application is reduced.

According to another aspect of the present disclosure, a first UI element is found to be defective in view of the first UI element being absent in the user interfaces of the modified application. A second UI element is found to be to be defective in view of a change in an attribute of the second UI element that would cause any test case designed to test the second UI element to fail.

According to one more aspect of the present disclosure, at a time instance prior to receiving the modified application (noted above), the application and the test suite is received and the identifiers of the UI elements in the user interfaces of the application is determined. The mapping data (noted above) is then generated by inspecting the test cases in the test suite for the presence of the identifiers of UI elements.

According to an aspect of the present invention, upon identifying the set of test cases that would fail the identified set of test cases is removed from the test suite to form an updated test suite. The testing of the modified application is then performed with the updated test suite.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

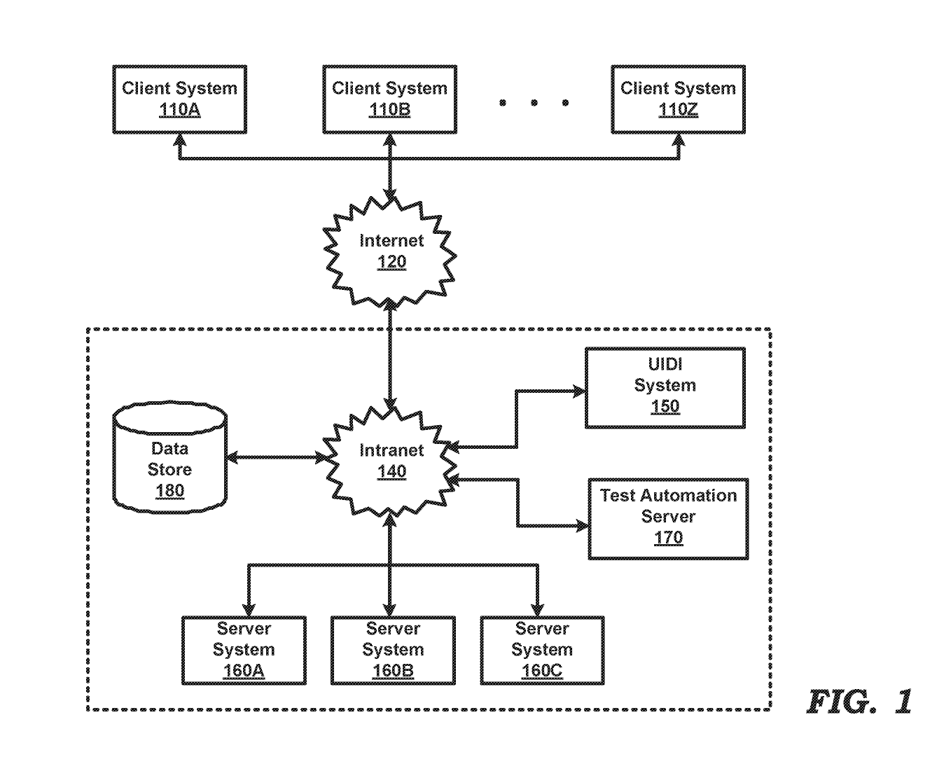

FIG. 1 is a block diagram illustrating an example environment (computing system) in which several aspects of the present invention can be implemented. The block diagram is shown containing client systems 110A-110Z, Internet 120, intranet 140, user interface defect identification (UIDI) system 150, test automation server 170, server systems 160A-160C and data store 180.

Merely for illustration, only representative number/type of systems is shown in FIG. 1. Many environments often contain many more systems, both in number and type, depending on the purpose for which the environment is designed. Each block of FIG. 1 is described below in further detail.

Intranet 140 represents a network providing connectivity between server systems 160A-160C, UIDI system 150, test automation server 170 and data store 180, all provided within an enterprise (as indicated by the dotted boundary). Internet 120 extends the connectivity of these (and other systems of the enterprise) with external systems such as client systems 110A-110Z. Each of intranet 140 and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and intranet 140. When the packet contains content such as port numbers, which specifies a target application, the packet may be said to be directed to such application as well.

Data store 180 represents a non-volatile (persistent) storage facilitating storage and retrieval of a collection of data by applications executing in server systems 160A-160C, test automation server 170 and UIDI system 150. Data store 180 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

Each of client systems 110A-110Z represents a system such as a personal computer, workstation, mobile device, computing tablet etc., used by users to generate (client) requests directed to enterprise applications executing in server system 160A-160C. The client requests may be generated using appropriate user interfaces (e.g., web pages provided by an enterprise application executing in a server system, a native user interface provided by a portion of an enterprise application downloaded from server systems, etc.). In general, an client system requests an enterprise application for performing desired tasks and receives the corresponding responses (e.g., web pages) containing the results of performance of the requested tasks. The web pages/responses may then be presented to the user by the client applications such as the browser. Each client request is sent in the form of an IP packet directed to the desired server system or enterprise application, with the IP packet including data identifying the desired tasks in the payload portion.

Each of server systems 160A-160C represents a server, such as a web/application server, executing enterprise applications performing tasks requested by users using one of client systems 110A-110Z. A server system may use data stored internally (for example, in a non-volatile storage/hard disk within the server system), external data (e.g., maintained in data store 180) and/or data received from external sources (e.g., from the user) in performing the requested tasks. The server system then sends the result of performance of the tasks to the requesting client system (one of 110A-110Z). The results may be accompanied by specific user interfaces (e.g., web pages) for displaying the results to the requesting user.

It may be appreciated that the enterprise applications executing in server systems 160A-160C may required to be tested to determine whether the applications operate consistent with desired functionalities. Such testing is commonly performed using test cases. As is well known, each test case is used to verify the compliance of an application under test (AUT) against a specific requirement. A test case typically specifies pre-conditions, test data, expected results and post-conditions, with testing using the test case entailing ensuring that pre-conditions and post-conditions are satisfied, providing the test data to the AUT and then determining whether the results generated by the AUT matches the expected results. If the generated results do not match the expected results, the test case is deemed to have failed and the AUT is deemed to be in non-compliance with the specific requirement (of the test case).

Test automation server 170 facilitates automated testing of enterprise applications executing in server systems 160A-160C. In particular, test automation server 170 receives a test suite containing a collection of automated test cases (each containing a test script), and then executes the test cases in a contiguous manner, without requiring human intervention. In addition, test automation server 170 also facilitates a user/tester to record interactions (e.g., providing the inputs) with a user interface of the AUT, and then generates a test script corresponding to such recorded interactions. Test automation server 170 may maintain the generated test scripts/automated test cases, the received test suite, the results of testing and any other desired intermediate data in data store 180.

There are several challenges to automated testing of user interfaces of an (enterprise) application. One challenge is that a modification to a user interface of an application may cause some of the prior automated test cases in a test suite to fail due to error in the performance of the test script/recorded interactions. In other words, the prior test cases fail due to incompatibility with the modified user interface, rather than due to error in functionality. However, in prior approaches, prior test cases having incompatibility are identified only after the completion of execution of the test suite.

UIDI system 150, provided according to several aspects of the present disclosure, determines incompatibilities of automated test cases with modified user interfaces prior to execution of the test suite as described below with examples.

### 3. Determining Incompatibilities of Automated Test Cases with Modified User Interfaces

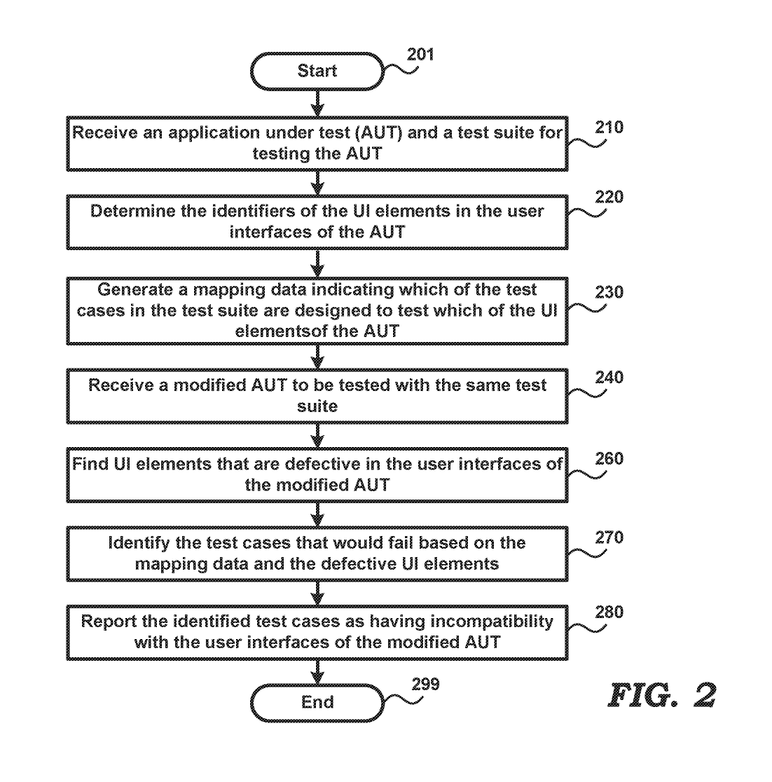

FIG. 2 is a flow chart illustrating the manner in which incompatibilities of automated test cases with modified user interfaces is determined according to an aspect of the present disclosure. The flowchart is described with respect to UIDI system 150 of FIG. 1 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, UIDI system 150 receives an application under test (AUT) and a test suite for testing the AUT. AUT may be one of the enterprise applications executing in server systems 160A-160C, with the test suite containing test cases/scripts designed to test various functionalities of the received AUT.

In step 220. UIDI system 150 determines the identifiers of the user interface (UI) elements in the user interfaces of the AUT. The determination of the identifiers may be performed in a known way. For example, when the user interfaces are corresponding web pages according to Hypertext Markup Language (HTML), the identifier of an UI element is specified by either one or a combination of HTML attributes associated with the UI element.

In step 230, UIDI system 150 generates a mapping data indicating which of the test cases in the test suite are designed to test which of the UI elements in the user interfaces of the AUT. In other words, the mapping data indicates for each test case in the test suite, the corresponding set of UI elements of the user interfaces of the AUT that the test case is designed to test. In one embodiment, UIDI system 150 inspects the text of each of the test cases/scripts in the received test suite for the presence of the identifiers determined in step 220, with the presence of an identifier indicating that the test case is designed to test the corresponding UI element.

In step 240, UIDI system 150 receives a modified AUT to test with the same test suite received in step 210. The modified AUT may contain modified user interfaces, that is, with the UI elements (in the user interface of the AUT received in step 210) modified to adapt to new requirements.

In step 260, UIDI system 150 finds the (set of) UI elements that are defective in the user interfaces of the modified AUT. UIDI system 150 may find that a UI element is defective by checking for the presence of the identifiers determined in step 220 in the user interfaces of the modified AUT. According to an aspect of the present disclosure, a UI element is found to be defective if the UI element is absent in the user interfaces of the modified AUT. According to another aspect, a UI element is found to be to be defective if a change in an attribute (e.g., x-coordinate, y-coordinate, width, height, color, etc.) of the UI element would cause any test case designed to test the UI element to fail. Combination of such conditions can also be a basis for determining that the UI element is defective.

In step 270, UIDI system 150 identifies the (set of) test cases in the test suite that would fail based on the mapping data and the defective UI elements. A test case is included in the identified set only if the test case is designed to test at least one UI element contained in the set of defective UI elements.

In step 280, UIDI system 150 reports the identified test cases as having incompatibility with the user interfaces of the modified AUT. For example, the identified test cases may be displayed to a tester/user, thereby facilitating the user to modify/correct the reported set of test cases prior to execution (using test automation server 170) of the test suite against the modified AUT.

According to an aspect of the present disclosure, in response to identifying the set of test cases that would fail in step 270, the identified set of test cases is removed from the test suite to form an updated test suite. The testing of the modified AUT is then performed by executing (using test automation server 170) the updated test suite against the modified AUT. The flow chart ends in step 299.

Thus, a user/tester is facilitated to determine incompatibilities of a test suite (containing automated test cases) with the modified user interfaces of a modified AUT prior to actual execution of the test suite. According to an aspect of the present disclosure, the turn-around time for identifying and fixing defects related to the user interfaces of an application (modified AUT) is reduced.

The manner in which UIDI system 150 determine incompatibilities of a test suite (containing automated test cases) with the modified user interfaces of a modified AUT according to FIG. 2 is illustrated below with examples.

### 4. Illustrative Example

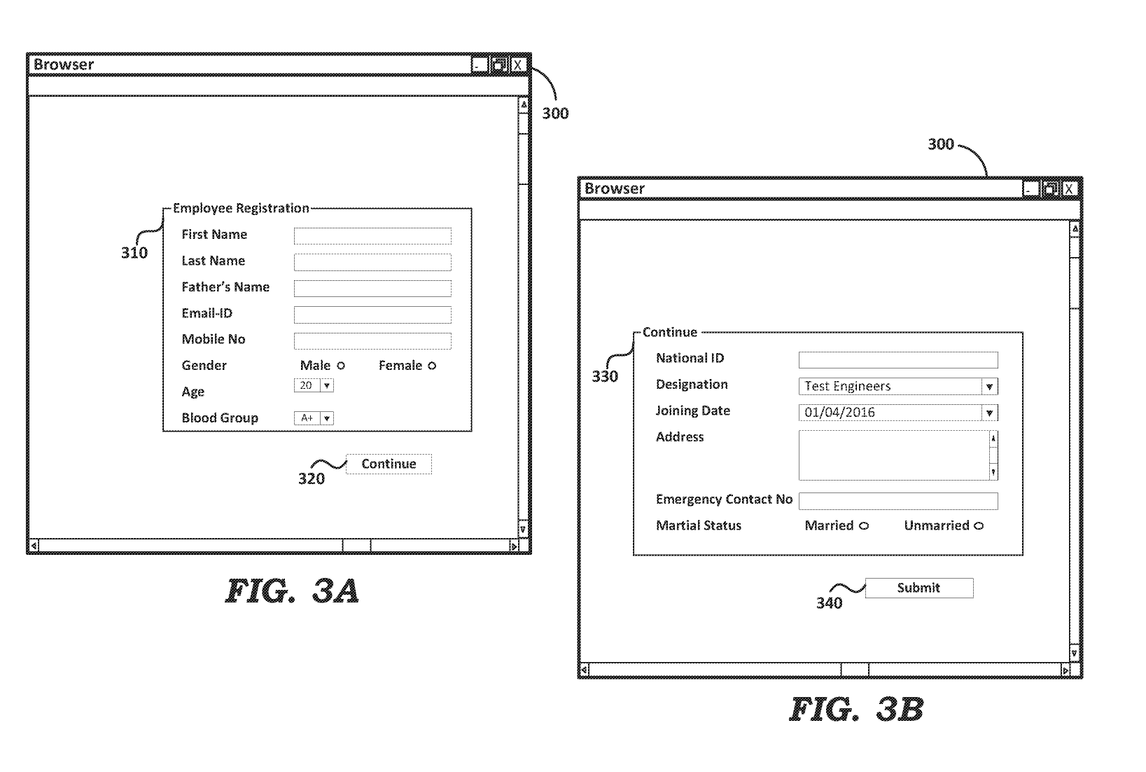

FIGS. 3A-3B, 4A-4B, 5A-5B and 6 together illustrate the manner in which the incompatibilities of automated test cases with modified user interfaces of a modified AUT is determined in one embodiment. Each of the Figures is described in detail below.

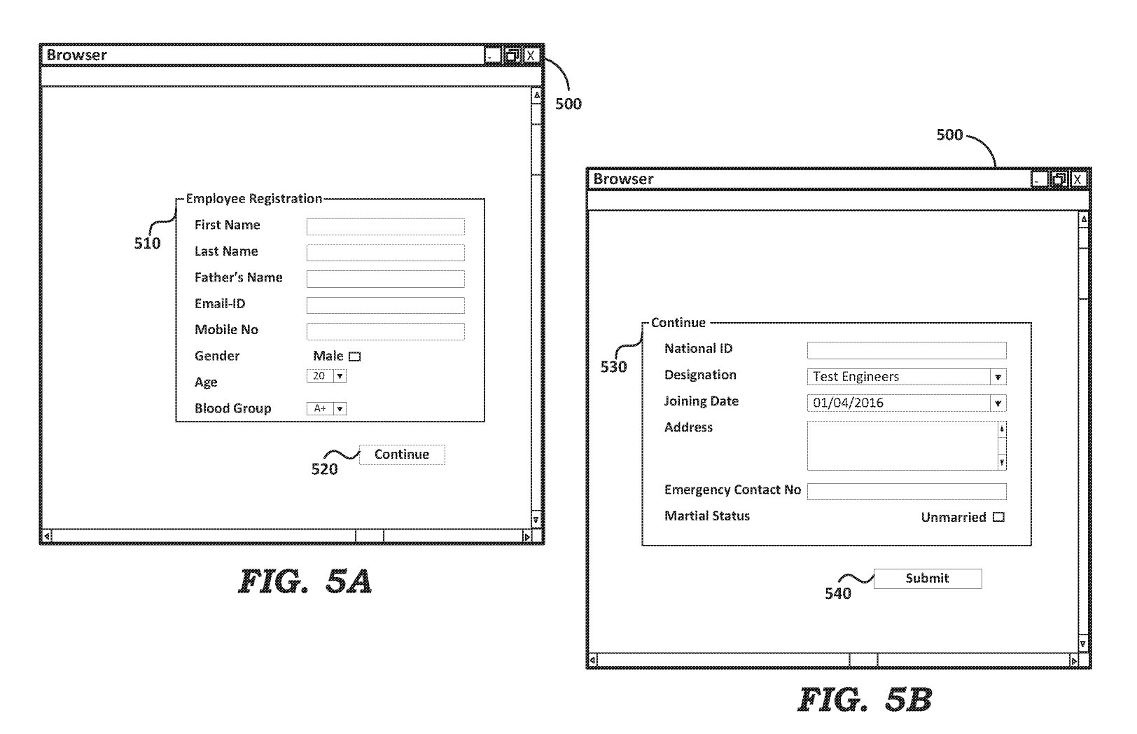

FIGS. 3A and 3B depicts sample user interfaces provided by an application in one embodiment. Display area 300 (and also display area 500 in FIGS. 5A and 5B) represents a portion of a user interface displayed on a display unit (not shown) associated with one of client systems 110A-110Z. In one embodiment, display area 300/500 corresponds to a web page rendered by a browser executing on the client system. Web pages are provided by a server system (one of 160A-160C) in response to a user sending appropriate requests (for example, by specifying corresponding URLs in the address bar) using the browser.

Display area 300 of FIG. 3A depicts a “Registration Home” web page that is displayed in the browser (executing in client system 110A, for illustration) in response to a user specifying a URL. The web page is provided by the application (executing in server system 160A, for illustration). Display area 310 depicts various user interface (UI) elements. Each UI element is shown in the form of a label (e.g. “First Name”) and a corresponding input element (the horizontal box shown alongside the label “First Name”). For convenience, in the following description, the UI elements are referred to by the corresponding labels. Thus, display area 310 is shown containing text fields (e.g., “First Name”, “Last Name”), radio buttons (e.g. “Male”, “Female”), drop down fields (e.g., “Age”), and web buttons (e.g. “Continue” 320), etc. A user may enter the desired data in the UI elements of display area 310 and then click/select “Continue” button 320.

Display area 300 of FIG. 3B depicts a “Finish Registration” web page (provided by the application) that is displayed in the browser upon a user clicking on the “Continue” button 320. Display area 330 depicts various UI elements (text fields, drop downs, web buttons, etc.) provided as part of the second web page. A user may enter the desired data in the UI elements of display area 330 and then click/select “Submit” button 340 to submit the details to server system 160A for further processing by the application.

It may be desirable that the application (providing the user interfaces shown in FIGS. 3A and 3B) be tested using a test suite containing automated test cases. Accordingly, UIDI system 150 receives the application to be tested (AUT) and the test suite. The AUT and test suite may be received in a known way. In one embodiment, UIDI system 150 provides a user interface (not shown) to a tester, who then receives identifiers of the text files/tables that contain the object data and mapping data (described below). Alternatively, UIDI system 150 may receive in the user interface, an identifier indicating a storage location (for example, an identifier of a directory in any of server systems 160A-160C and/or data store 180) where the user interfaces of the application and the test suite are stored.

UIDI system 150 then determines the details (including identifiers) of the UI elements in the user interfaces of FIGS. 3A and 3B. As noted above, UIDI system 150 inspects the HTML forming the “Registration Home” and “Finish Registration” web pages, and determines the details of each UI element based on the values corresponding to one or a combination of HTML attributes/properties associated with the UI element. UIDI system 150 then maintains (as object data) the details of the UI elements determined in the user interfaces of the AUT as described below with examples.

### 5. Object Data and Mapping Data

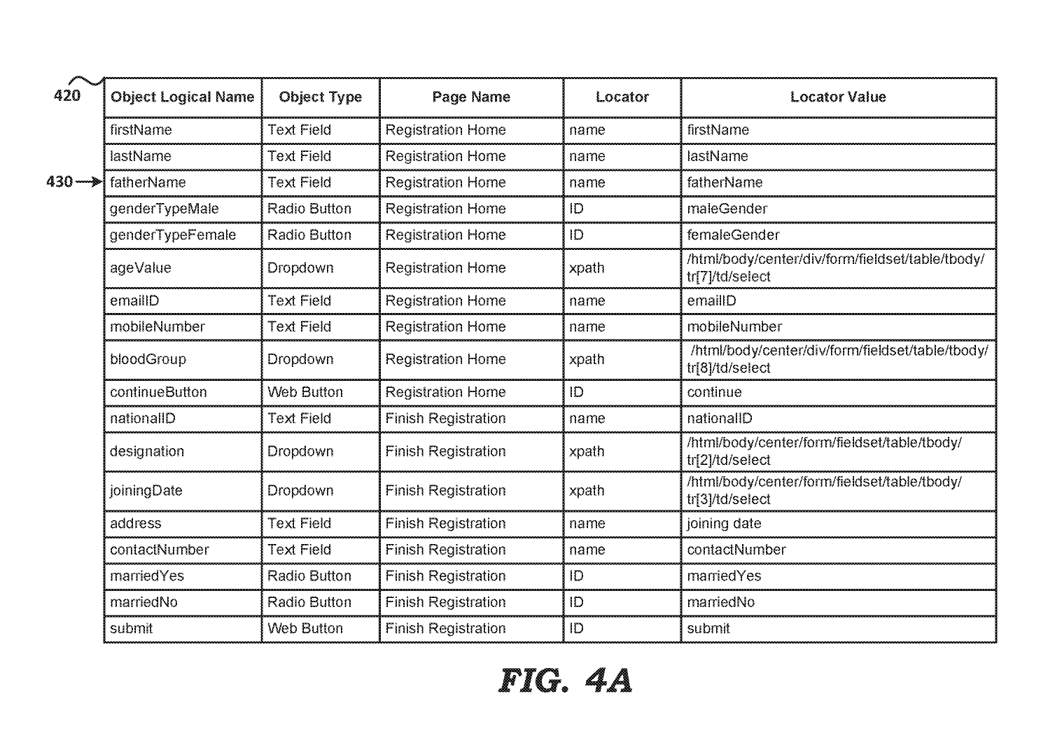

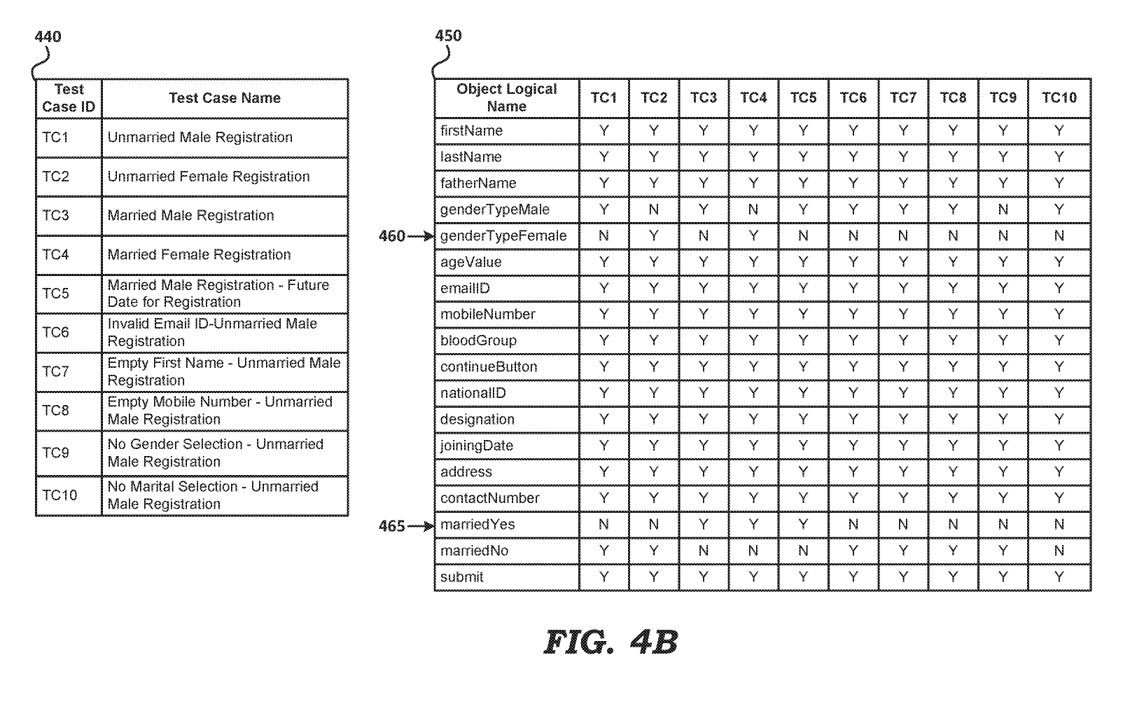

FIG. 4A depicts portions of an object data specifying the details of UI elements in the user interfaces of an application under test in one embodiment. For illustration, the object data (and the mapping data described below) are assumed to be maintained in the form of tables in data store 180. However, in alternative embodiments, the object data and mapping data may be maintained according to other data formats (such as files according to extensible markup language (XML), etc.) and/or using other data structures (such as lists, trees, etc.), as will be apparent to one skilled in the relevant arts by reading the disclosure herein.

Table 420 depicts object data specifying the details of the UI elements in the user interfaces of FIGS. 3A and 3B. Each of the rows of table 420 specifies the details of a corresponding UI element in the user interfaces (FIGS. 3A and 3B) of the received application under test.

In particular, column “Object Logical Name” indicates a corresponding logical name/identifier of each UI element, column “Object Type” indicates the type (such as text field, radio button, drop box, web button, etc.) of the UI element, and column “Page Name” indicates the name of the web page (that is “Registration Home” or “Finish Registration”) in which the UI element is present. The object logical name of an UI element may be determined as the value corresponding to “name” or “ID” HTML attributes, while the type may be determined as the value corresponding to “type” HTML attribute, as will be apparent to one skilled in the relevant arts.

Table 420 also contains columns “Locator” and “Locator Value” which respectively indicate the name and corresponding value of a HTML attribute/property used for locating the UI element in the web page. The combination of the “Locator” and “Locator Value” is used to determine the presence of the UI element in the corresponding web page. For example, row 430 indicates that a UI element having the identifier “fatherName” is present only if there is any UI element in the web page that has a HTML attribute/property “name” having the value “fatherName”. If there is no such UI element in the web page, the UI element “fatherName” is deemed absent in the web page.

Thus, UIDI system 150 maintains the details of the UI elements in the user interfaces of a received AUT. UIDI system 150 then generates mapping data indicating which of the test cases in the received test suite are designed to test which of the UI elements of table 420, as described below with examples.

FIG. 4B depicts portions of a mapping data specifying which of the test cases in a test suite are designed to test which of the UI elements of an application under test in one embodiment. As noted above, the mapping data may be maintained in data store 180.

Table 440 specifies the details of the automated test cases in the received test suite. Each of rows in table 440 specifies the details of a corresponding automated test case in the received test suite. In particular, column “Test Case ID” indicates a unique identifier associated with each automated test case, while column “Test Case Name” indicates a corresponding name associated with the automated test case.

UIDI system 150 inspects the text of each of the automated test cases/scripts shown in table 440 for the presence of the identifiers (column “Object Logical Name”) of the UI elements shown in table 420. The presence of an identifier of an UI element indicates that the test case is designed to test the corresponding UI element.

Table 450 shows a mapping data generated for the test cases of table 440 and UI elements of table 420. The test case identifiers of table 440 are shown as columns along a first/horizontal dimension, while the object logical names/identifiers of the UI elements of table 420 are shown as rows along a second/vertical dimension. A cell at the intersection of a row/UI element and a column/test case has either the value “Y” (Yes) indicating that the test case is designed to test the UI element or the value “N” (No) indicating that the test case is not designed to test the UI element.

As such, row 460 indicates that the UI element “genderTypeFemale” is designed to be tested by the automated test cases TC2 and TC4, while row 465 indicates that the UI element “marriedYes” is to be tested by the test cases TC3, TC4, and TC5. It should be noted that only a sample set of UI elements and test cases are shown herein for illustration, and in actual embodiments, the number/type of UI elements and test cases may vary as suitable to the environment in which the features of the present disclosure are sought to be implemented. The mapping data of table 450 may then be maintained as suitable to such environments.

Thus, UIDI system 150 generates and maintains a mapping data specifying a mapping between the test cases of a test suite and the UI elements of an application under test (AUT). UIDI system 150 may then receive, at a time instance after the mapping data is generated and stored in data store 180, a modified AUT containing possibly modified user interfaces, as described below with examples.

### 6. Modified AUT and Determining Incompatibilities

FIGS. 5A and 5B depicts sample user interfaces provided by a modified application in one embodiment. As noted above, display area 500 is similar to display area 300 and represents web pages rendered by a browser executing on a client system (110A). Display area 500 of FIGS. 5A and 5B respectively depicts the “Registration Home” and “Finish Registration” web pages provided by the modified application.

Elements 510, 520, 530 and 540 are similar to elements 310, 320, 330 and 340 and accordingly their description is not repeated herein for conciseness. However, it may be observed that the UI element “Female” radio button is not present in display area 510, and the UI element “Married” radio button is not present in display area 530.

UIDI system 150, upon receiving the modified AUT, finds the set of UI elements that are defective in the modified user interfaces (FIGS. 5A and 5B) of the modified AUT. As noted above, a UI element is found to be defective if the UI element is absent in the user interfaces of the modified AUT. UIDI system 150 accordingly determines, for each UI element in table 420, whether the corresponding locator and locator value are present in the HTML of the modified user interfaces of FIGS. 5A and 5B. Any UI element of table 420 that is determined to be not present in the user interfaces (web pages noted above) of the modified AUT is added to the set of defective UI elements.

Additional techniques may be employed to finding the set of defective UI elements. For example, UIDI system 150 may first check whether each user interface (e.g. Registration Home” web page) of the AUT is present in the user interfaces of the modified AUT. In a scenario that a specific user interface is not present, UIDI system 150 includes all of the UI elements contained in the specific user interface to the set of defective UI elements.

After finding the set of defective UI elements, UIDI system 150 identifies the test cases of table 440 that are designed to test at least one UI element contained in the set of defective UI elements. The identified set of test cases is then reported as having incompatibility with the modified user interfaces of FIGS. 5A and 5B. The manner in which UIDI system 150 identifies incompatible test cases is described below with examples.

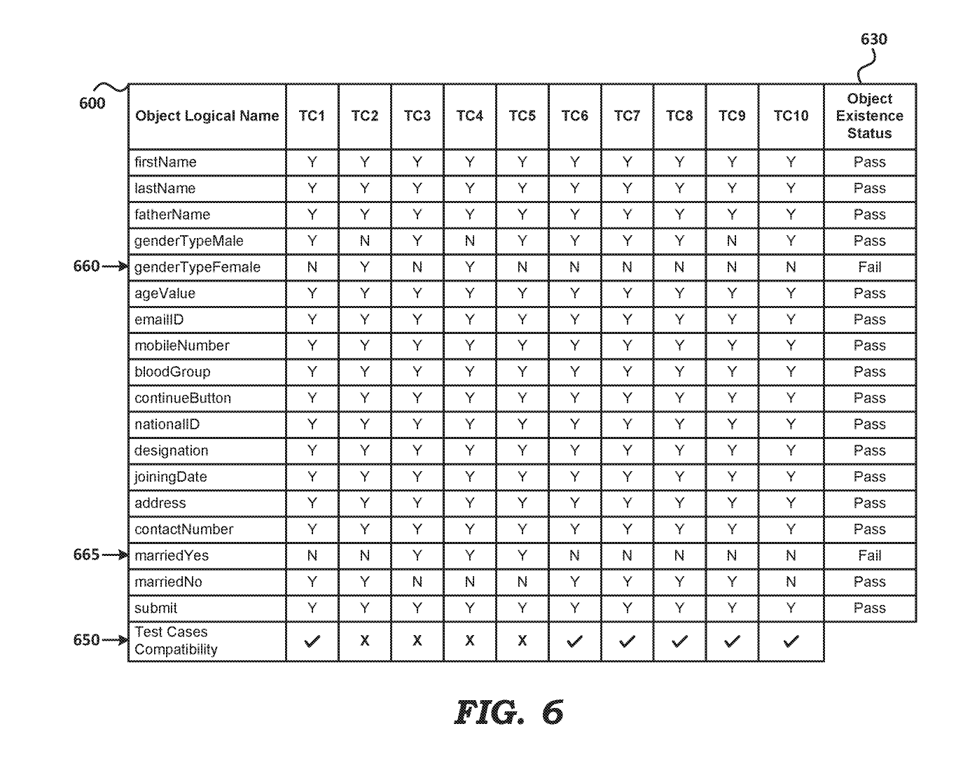

FIG. 6 illustrates the manner in which test cases in a test suite that have incompatibility with the modified user interfaces of a modified application is determined in one embodiment. Table 600 is similar to table 450 in that the test case identifiers are shown as columns along a first/horizontal dimension, while the object logical names/identifiers of the UI elements of table 420 are shown as rows along a second/vertical dimension. The value in each cell at the intersection of an object logical name and a test case identifier in table 600 is the same as the value in the corresponding cell in table 450.

Table 600 is shown having an additional column 630 (“Object Existence Status”) which indicates whether the corresponding UI element is present (value “Pass”) or absent (value “Fail”) in the modified user interfaces (FIGS. 5A and 5B) of the modified AUT. It may be observed that the UI elements “genderTypeFemale” and “marriedYes” in rows 660 and 665 are indicated to be absent (value “Fail” in column 630) in the modified user interfaces of FIGS. 5A and 5B.

Table 600 is also shown having an additional row 650, which indicates the compatibility of each test case with the UI elements in the modified user interfaces. A tick mark shown in row 650 indicates that the test case is compatible with the modified user interfaces of the modified application, with a cross mark (in row 650) indicating incompatibility. The marks may be generated by determining for each column/test case, whether there is at least one cell in that column which has a “Y” (yes) value and where the corresponding UI element/row has a “Fail” value in column 630. If such a cell is present, the test case/column is marked as incompatible (cross mark), and if no such cells are present, the test case/column is marked as compatible (tick mark).

For example, for test case TC2, it may be observed that the cell at the intersection of the column TC2 and row 660 has a value “Y”, with the corresponding value in column 630 (of row 660) being “Fail”. Accordingly, TC2 is identified as an automated test case that is incompatible (as indicated by the cross mark in row 650) with the modified user interfaces of the modified AUT. Similarly, other test cases/columns having incompatibility with the modified user interfaces are identified.

UIDI system 150 then identifies {TC2, TC3, TC4, TC5} as the set of test cases having incompatibility with the modified user interfaces of FIGS. 5A and 5B. The identified set is then displayed/reported to a user/tested, thereby facilitating the user to modify/correct the reported set of test cases prior to execution of the test suite. According to an aspect of the present disclosure, an updated test suite is formed by removing the set of tests cases identified as having incompatibility and the modified AUT is tested with the updated test suite. In the above example, test suite is updated as {TC1, TC6, TC7, TC8, TC9, TC10} and the modified AUT and the updated test suite is sent to test automation server 170. Test automation server 170 thereafter executes the test cases in the updated test suite against the modified AUT to determine functionality defects in the modified AUT.

In the description above, a UI element is found to be defective in a modified user interface if the UI element is absent in the modified user interface. However, in alternative embodiment, a UI element may be found to be defective if there is a change in an HTML attribute/property (e.g., x-coordinate, y-coordinate, width, height, color, etc.) of the UI element that would cause any automated test case designed to test the UI element to fail. For example, an automated test case may be generated by recording a specific position of the UI element in the (original) user interface of the AUT, and accordingly any change in the position of the UI element in the modified user interface of the modified AUT would cause the automated test case to fail. In such scenarios as well, the UI element having the changed position is found to be defective.

It should be noted that the incompatibility of an automated test case with a modified user interface arises due to absence of/change in the UI elements in the modified user interface (in comparison to the original user interface). Aspects of the present disclosure are directed to identifying such incompatibilities and not the change in functionality (e.g. actions performed upon a button click, the significance of an input data entered by a user, etc.) associated with the UI elements in the modified user interfaces of the modified AUT.

In one embodiment, aspect of the present disclosure reduces the turn-around time for identifying and fixing defects related to the user interfaces of an application as described below with examples.

### 7. Reducing Turn-Around Time

Turn-around time for testing refers to total time taken between the submission of an application for testing and the return of the application with all the defects identified and fixed in the application. The turn-around time is typically the sum of the time taken for testing the application, the time taken for analyzing the defects identified during testing, and the time taken for fixing the defects.

In prior approaches, the turn-around time for identifying and fixing defects related to changes in user interfaces of an application is high since the UI defects are identified only upon execution of the complete test suite (which may take from few hours to many days). For example, the testing of an application containing 2000 UI elements using a test suite containing 700 automated test cases typically takes 120 hours. As such, according to the prior approaches, even though the modified application contains 10% (that is, 200) defective UI elements, the turn-around time would be more than 120 hours (that is 120+ hours).

Aspects of the present disclosure reduce such high turn-around time of identifying and fixing defects related to modified user interfaces by identifying the test cases that are incompatible with the modified use interfaces (without requiring the execution of the test suite). In the above example, assuming that the finding of a defective UI element has a time out duration of 30 seconds and the identification of the presence of an UI takes 5 seconds, the time taken for determining the defects in the modified user interfaces around by UIDI system 150 is 2000*10%*30+2000*90%*5=4.2 hours. Accordingly, the turn-around time for identifying and fixing defects related to user interfaces of an application is reduced.

Though described above with respect to automated testing of an application, it should be appreciated that the aspects of the present disclosure can be implemented in other contexts as well. For example, UIDI system 150 may be used in combination with a code versioning system (not shown) such that aspects of the present disclosure are operable during the code-check-in process. Thus, before or after a new code check-in, testers or developers are enabled to verify whether the new code causes any user interface related defects.

It should be further appreciated that the features described above can be implemented in various embodiments as a desired combination of one or more of hardware, executable modules, and firmware. The description is continued with respect to an embodiment in which various features are operative when the software instructions described above are executed.

### 8. Digital Processing System

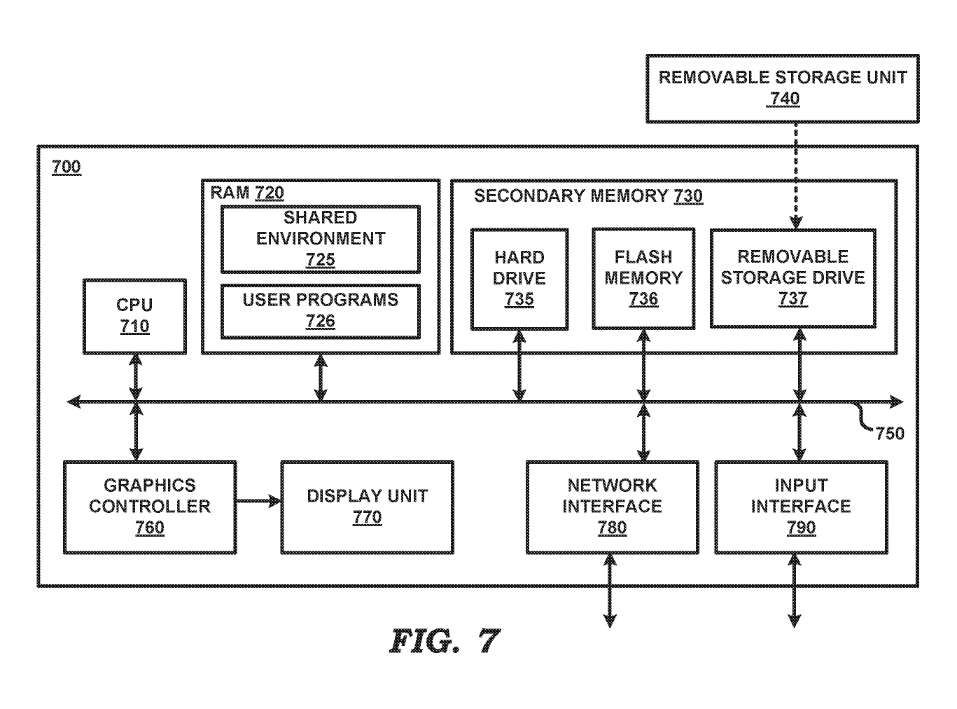

FIG. 7 is a block diagram illustrating the details of digital processing system 700 in which various aspects of the present disclosure are operative by execution of appropriate executable modules. Digital processing system 700 corresponds to user interface defect identification (UIDI) system 150.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals (e.g., portions of the user interfaces of FIGS. 3A, 3B and 5A and 5B). Input interface 790 may correspond to a keyboard and a pointing device (e.g., touch-pad, mouse) that may be used to provide appropriate inputs (e.g., for providing inputs to the user interfaces of FIGS. 3A, 3B and 5A and 5B). Network interface 780 provides connectivity to a network (e.g., using Internet Protocol), and may be used to communicate with other systems (of FIG. 1) connected to the network (140/120).

Secondary memory 730 may contain hard drive 735, flash memory 736, and removable storage drive 737. Secondary memory 730 may store the data (for example, portions of the data shown in FIGS. 4A-4B and 6) and software instructions (for implementing the flowchart of FIG. 2), which enable digital processing system 700 to provide several features in accordance with the present disclosure. The code/instructions stored in secondary memory 730 either may be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

What is claimed is:

1. A method of determining incompatibilities of automated test cases with modified user interfaces, said method comprising:
maintaining a mapping data between a plurality of test cases in a test suite and a plurality of user interface (UI) elements in the user interfaces of an application, said test suite being designed to test the functionalities of said application,
wherein said mapping data indicates for each test case of said plurality of test cases, the corresponding UI elements of said plurality of UI elements that the test case is designed to test;
receiving a modified application that is to be tested with said test suite, said modified application being a modified version of said application;
finding a first set of UI elements that are defective in the user interfaces of said modified application, wherein said first set of UI elements is contained in said plurality of UI elements;
identifying a first set of test cases contained in said plurality of test cases that would fail based on said mapping data and said first set of UI elements; and
reporting said first set of test cases as having incompatibility with the user interfaces of said modified application.

2. The method of claim 1, wherein said identifying includes a test case of said plurality of test cases in said first set of test cases only if said test case is designed to test at least one UI element contained in said first set of UI elements.

3. The method of claim 2, wherein said finding finds a first UI element of said plurality of UI elements to be defective in view of said first UI element being absent in the user interfaces of said modified application.

4. The method of claim 3, wherein said finding finds a second UI element of said plurality of UI elements to be defective in view of a change in an attribute of said second UI element that would cause any test case designed to test said second UI element to fail.

5. The method of claim 1, wherein said receiving receives said modified application at a first time instance, said method further comprising:
receiving at a second time instance prior to said first time instance, said application and said test suite;
determining the identifiers of said plurality of UI elements in the user interfaces of said application; and
generating said mapping data by inspecting said plurality of test cases in said test suite for the presence of said identifiers of said plurality of UI elements.

6. The method of claim 1, further comprising:
removing said first set of test cases from said plurality of test cases to form an updated test suite; and
testing said modified application with said updated test suite.

7. A non-transitory machine readable medium storing one or more sequences of instructions for causing a system to determine incompatibilities of automated test cases with modified user interfaces, wherein execution of said one or more instructions by one or more processors contained in said system causes said system to perform the actions of:
maintaining a mapping data between a plurality of test cases in a test suite and a plurality of user interface (UI) elements in the user interfaces of an application, said test suite being designed to test the functionalities of said application,
wherein said mapping data indicates for each test case of said plurality of test cases, the corresponding UI elements of said plurality of UI elements that the test case is designed to test;
receiving a modified application that is to be tested with said test suite, said modified application being a modified version of said application;
finding a first set of UI elements that are defective in the user interfaces of said modified application, wherein said first set of UI elements is contained in said plurality of UI elements;
identifying a first set of test cases contained in said plurality of test cases that would fail based on said mapping data and said first set of UI elements; and
reporting said first set of test cases as having incompatibility with the user interfaces of said modified application.

8. The non-transitory machine readable medium of claim 7, wherein said identifying includes a test case of said plurality of test cases in said first set of test cases only if said test case is designed to test at least one UI element contained in said first set of UI elements.

9. The non-transitory machine readable medium of claim 8, wherein said finding finds a first UI element of said plurality of UI elements to be defective in view of said first UI element being absent in the user interfaces of said modified application.

10. The non-transitory machine readable medium of claim 9, wherein said finding finds a second UI element of said plurality of UI elements to be defective in view of a change in an attribute of said second UI element that would cause any test case designed to test said second UI element to fail.

11. The non-transitory machine readable medium of claim 7, wherein said receiving receives said modified application at a first time instance, further comprising one or more instructions for:
receiving at a second time instance prior to said first time instance, said application and said test suite;
determining the identifiers of said plurality of UI elements in the user interfaces of said application; and
generating said mapping data by inspecting said plurality of test cases in said test suite for the presence of said identifiers of said plurality of UI elements.

12. The non-transitory machine readable medium of claim 7, further comprising one or more instructions for:
removing said first set of test cases from said plurality of test cases to form an updated test suite; and
testing said modified application with said updated test suite.

13. A digital processing system comprising:
a processor;
a random access memory (RAM);
a machine readable medium to store one or more instructions, which when retrieved into said RAM and executed by said processor causes said digital processing system to determine incompatibilities of automated test cases with modified user interfaces, said digital processing system performing the actions of:
maintaining a mapping data between a plurality of test cases in a test suite and a plurality of user interface (UI) elements in the user interfaces of an application, said test suite being designed to test the functionalities of said application,
wherein said mapping data indicates for each test case of said plurality of test cases, the corresponding UI elements of said plurality of UI elements that the test case is designed to test;
receiving a modified application that is to be tested with said test suite, said modified application being a modified version of said application;
finding a first set of UI elements that are defective in the user interfaces of said modified application, wherein said first set of UI elements is contained in said plurality of UI elements;
identifying a first set of test cases contained in said plurality of test cases that would fail based on said mapping data and said first set of UI elements; and
reporting said first set of test cases as having incompatibility with the user interfaces of said modified application.

14. The digital processing system of claim 13, wherein said digital processing system includes a test case of said plurality of test cases in said first set of test cases only if said test case is designed to test at least one UI element contained in said first set of UI elements.

15. The digital processing system of claim 14, wherein said digital processing system finds a first UI element of said plurality of UI elements to be defective in view of said first UI element being absent in the user interfaces of said modified application.

16. The digital processing system of claim 15, wherein said digital processing system finds a second UI element of said plurality of UI elements to be defective in view of a change in an attribute of said second UI element that would cause any test case designed to test said second UI element to fail.

17. The digital processing system of claim 13, wherein said digital processing system receives said modified application at a first time instance, further performing the actions of:
receiving at a second time instance prior to said first time instance, said application and said test suite;
determining the identifiers of said plurality of UI elements in the user interfaces of said application; and
generating said mapping data by inspecting said plurality of test cases in said test suite for the presence of said identifiers of said plurality of UI elements.

18. The digital processing system of claim 13, further performing the actions of:
removing said first set of test cases from said plurality of test cases to form an updated test suite; and
testing said modified application with said updated test suite.
